(19) United States
(12) Patent Application Publication
(10) Pub. No.: US 2011/0273742 A1
(43) Pub. Date: Nov. 10, 2011

(54) ELECTRONIC APPARATUS, IMAGE FORMING APPARATUS, AND COMPUTER PROGRAM PRODUCT

(76) Inventor: Akira TAKIGUCHI, Kanagawa (JP)

(21) Appl. No.: 13/080,860

(22) Filed: Apr. 6, 2011

(30) Foreign Application Priority Data
May 7, 2010 (JP) 2010-107276

(51) Int. Cl. G06F 3/12; G06F 1/32; H02J 4/00

(52) U.S. Cl. 358/1.15; 307/32; 700/295

(57) ABSTRACT

An electronic apparatus includes: a plurality of load units; a power supply unit; and a power control unit that controls power to be supplied only to a load unit which requires power all the time from the power supply unit for a light load during an energy saving state, and controls power to be supplied to a load unit which requires power all the time during an operating state from the power supply unit for a light load, and at the same time, controls deficient power of the load unit to be supplemented by the power supply unit for a heavy load during the operating state, wherein a state of the electronic apparatus can be switched to the operating state or the energy saving state.

### CROSS-REFERENCE TO RELATED APPLICATIONS

The present application claims priority to and incorporates by reference the entire contents of Japanese Patent Application No. 2010-107276 filed in Japan on May 7, 2010.

### BACKGROUND OF THE INVENTION

1. Field of the Invention

The present invention relates to an electronic apparatus such as a personal computer (hereinafter, abbreviated as a “PC”); an image forming apparatus such as a digital multifunction peripheral, a digital copying machine, a facsimile device, and a laser printer; and a computer program product used for implementing necessary functions (functions relating to the invention) in a computer that controls the electronic apparatus, and more particularly, relates to a technology for saving the energy (briefly referred to as “energy saving”).

2. Description of the Related Art

In an image forming apparatus using an electro-photographic method such as a digital multifunction peripheral (MFP) and a laser printer (LP), an image generating process unit, which is configured as a charging unit, an exposing unit, a developing unit, and a transfer unit, is included on the periphery of a drum-shaped or belt-shaped photosensitive element serving as an image carrier, and a fixing unit using a thermal fixing method is also included, thereby an image forming operation described as below is performed. The surface of the photosensitive element that rotates is uniformly charged by the charging unit; and the surface is exposed through scanning of light beams, which are modulated in accordance with image data and emitted from the exposing unit, so as to form an electrostatic latent image. Then, the electrostatic latent image is developed with toner supplied from the developing unit so as to form a toner image. Thereafter, the toner image is directly transferred onto a transfer sheet serving as a transfer material (recording medium) by the transfer unit, or the toner image is transferred onto a belt-shaped or drum-shaped intermediate transfer body and then is transferred onto a transfer sheet. The transfer sheet, onto which the toner image is transferred, is heated and fixed by the fixing unit and is discharged.

In such an image forming apparatus, the amount of power consumption of the fixing unit and at the time of waiting (also referred to as “at the time of the waiting state,” “at the time of the energy saving state,” “at the time of the energy saving mode,” or “at the time of the energy saving”) is occupied about 70% of the total power consumption of the apparatus; and in order to solve an environmental issue, there is a request for reducing the power consumption.

For reducing the amount of power consumption at the time of waiting, it is important to reduce the power consumption of a controller having an energy-saving control function built therein and to improve the use efficiency (power efficiency) of a power supply unit (PSU) serving as a power supply means that supplies power to the controller. In addition, in order to improve the power efficiency of the PSU that supplies power to the controller at the waiting time, it is also important to implement both a high efficiency at the time of a heavy load (at the time of operating) when the power consumption increases as load units (a driving system such as an engine controller or a fan disposed inside the engine unit and a CPU or the like disposed inside the main controller) that consume much power are used, and a high efficiency at the time of a light load (at the time of the energy saving) when the power consumption is lowered as load units (a RAM disposed inside the main controller or the like) that do not consume much power are used.

Thus, as a method of implementing the high power efficiency of the PSU both at the time of a heavy load and at the time of a light load, there is already known a technique in which the high power efficiency of the PSU is realized by mounting, for example, first and second converters as two converters (power supply units), changing the converter between at the time of waiting and at the time of operating (also referred to as “at the time of an operating state,” “at the time of a normal state,” “at the time of an operation mode,” or “at the time of a normal mode”) so as to allow the first converter (a power supply unit for a light load) to supply power to control system blocks (load units) that require power all the time even at the time of waiting and the second converter (a power supply unit for a heavy load) to supply power to the control and driving system blocks (load units) that require power only at the time of operating, and setting the change between in the two in accordance with the load conditions.

However, even for a technique in which the high efficiency of the power source is realized at the time of a light load by arranging the first converter that supplies power to the control system blocks requiring power all the time even at the time of waiting (at the time of energy saving), there is a demand for a higher efficiency, so that the reduction of the power at the time of waiting (a necessity for realizing a high efficiency through positioning a lighter load) is demanded. However, since the range of the load that is covered by the first converter is widened (the maximum current increases) due to an increase in the load (for example, an increase on the power consumption of the RAM) when the control system blocks requiring power all the time operate, there is a problem in that the power efficiency at the time of waiting decreases.

In order to solve the above-mentioned problem, for example, the technologies disclosed in Japanese Patent Application Laid-open No. 2002-010492 and Japanese Patent Application Laid-open No. 2003-291459 may be considered to be used.

In Japanese Patent Application Laid-open No. 2002-010492, in order to reduce the reactive power at the time of waiting (at the time of energy saving) when the power consumption is low, a configuration is disclosed in which there are included a first power supply device (corresponding to a power supply unit for a light load that is also in the on state even at the time of energy saving) that is turned on all the time (hereinafter, “on” may be also expressed as “ON”); an energy-saving control unit that is supplied with power from the first power supply device; and a second power supply device (corresponding to a power supply unit for a heavy load that is turned on at the time of operating and is turned off at the time of energy saving) that is a controller to be turned on or off by the energy-saving control unit, and the second power supply device is turned off (hereinafter, “off” may be also expressed as “OFF”) at the time of energy saving so as to stop the supply of power.

In addition, in Japanese Patent Application Laid-open No. 2003-291459, in order to improve the energy saving effect, a configuration is disclosed in which a power supply device having two or more types of voltage output systems (converters serving as power supply units) is included; and the output voltage supplied from a low-voltage output system (corresponding to a power supply unit for a light load) is lowered than that at the time of image formation (at the time of the operation); and the output of a voltage from a high voltage output system (corresponding to a power supply unit for a heavy load) is blocked, at the time of non-image formation (at the time of waiting).

However, in Japanese Patent Application Laid-open No. 2002-010492 and Japanese Patent Application Laid-open No. 2003-291459, the power consumption at the time of waiting can be reduced by maintaining only the on-state of the power supply unit for a light load at the time of waiting. However, since the range of the load capacity that is covered by the power supply unit for a light load is widened due to the increase in the power consumption at the time of operating load units requiring power all the time, the problem of decreasing the efficiency of the power source at the time of waiting is not solved.

### SUMMARY OF THE INVENTION

It is an object of the present invention to at least partially solve the problems in the conventional technology.

According to an aspect of the present invention, there is provided an electronic apparatus including: a plurality of load units that require power; a power supply unit that supplies power to the plurality of load units, the power supply units including a power supply unit for a heavy load and a power supply unit for a light load; and a power control unit that controls power to be supplied only to a load unit which requires power all the time, out of a plurality of load units, from the power supply unit for a light load during an energy saving state, and controls power to be supplied to a load unit which requires power all the time during an operating state from the power supply unit for a light load, and at the same time, controls deficient power of the load unit to be supplemented by the power supply unit for a heavy load during the operating state, wherein a state of the electronic apparatus can be switched to any one of a plurality of apparatus states including the operating state in which a normal operation is performed and the energy saving state in which power consumption can be reduced.

According to another aspect of the present invention, there is provided an image forming apparatus configured as the electronic apparatus mentioned above, including: an image forming unit that forms an image on a recording medium; a communication unit that communicates with outside the apparatus; and a main control unit that performs overall control of the apparatus, wherein the load unit which requires power all the time, out of the plurality of load units, includes a portion of the power control unit disposed inside the communication unit and the main control unit, and the load unit other than the load unit which requires power all the time, out of the plurality of load units, includes a remaining portion disposed inside the main control unit and the image forming unit.

According to still another aspect of the present invention, there is provided a computer program product including a non-transitory computer-usable medium having computer-readable program codes embodied in the medium for controlling an electronic apparatus that includes a plurality of load units that require power, and a power supply unit for a heavy load and a power supply unit for a light load that supply power to the plurality of load units, and switches a state of the electronic apparatus to any one of a plurality of apparatus states including an operating state in which a normal operation is performed and an energy saving state in which power consumption is reduced, the program codes when executed causing a computer to execute: controlling, during the energy saving state, power to be supplied only to a load unit which requires power all the time, out of the plurality of load units, from the power supply unit for a light load; and controlling power to be supplied to a load unit which requires power all the time from the power supply unit for a light load, and also controlling deficient power of the load unit to be supplemented by the power supply unit for a heavy load during the operating state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of the hardware configuration of an MFP as an image forming apparatus according to a first embodiment of the invention;

FIGS. 2A to 2C are waveform diagrams illustrating examples of the power efficiency of power supply units (PSU) according to a “One-Converter Type (Conventional)”, a “Two-Converter Type (Conventional)”, and a “Two-Converter Supplementary Type”;

FIG. 3 is a timing chart illustrating the relation between the ON/OFF states of a PSU, a main controller, an engine controller, and a facsimile (FAX) controller illustrated in FIG. 1 and the power consumption;

FIG. 4 is a block diagram illustrating an example of the hardware configuration of an MFP as an image forming apparatus according to a second embodiment of the invention;

FIG. 5 is a table illustrating the power supply state of the MFP illustrated in FIG. 4;

FIG. 6 is a block diagram illustrating an example of the hardware configuration of an MFP as an image forming apparatus according to a third embodiment of the invention;

FIG. 7 is a waveform diagram illustrating an example of the relation among the input voltage of a main controller, the output voltage of an energy-saving dedicated converter, and the output voltage of a heavy-load correspondence converter illustrated in FIG. 6;

FIG. 8 is a timing chart illustrating an example of the operation timing of a PSU and a main controller shown in FIG. 6;

FIG. 9 is a block diagram illustrating an example of the hardware configuration of an MFP as an image forming apparatus according to a fourth embodiment of the invention;

FIG. 10 is a waveform diagram illustrating an example of the relation among the input voltage of a main controller, the output voltage of an energy-saving dedicated converter, and the output voltage of a heavy-load correspondence converter illustrated in FIG. 9;

FIG. 11 is a timing chart illustrating an example of the operation timing of a PSU and a main controller illustrated in FIG. 9;

FIG. 12 is a block diagram illustrating an example of the hardware configuration of an MFP as an image forming apparatus according to a fifth embodiment of the invention;

FIG. 13 is a schematic diagram illustrating a detailed state transition and the power efficiency of an MFP illustrated in FIG. 12; and

FIG. 14 is a waveform diagram illustrating an example of the power efficiency of the PSU illustrated in FIG. 12.

### DETAILED DESCRIPTION OF THE PREFERRED EMBODIMENTS

Hereinafter, embodiments of the invention will be described in detail with reference to the accompanying drawings.

This embodiment of the invention has the following features regarding the improvement in the power efficiency at the time of power-saving mode (waiting state) of an electronic apparatus. According to this embodiment, by supplementing power generated by an energy-saving dedicated converter as a power supply unit for a light load with power generated by a normal converter as a power supply unit for a heavy load at the time of an operating state (heavy load), the range of the load capacity that is covered by the energy-saving dedicated converter can be configured to be narrow, whereby high power efficiency both at the time of the operating state (heavy load) and at the time of energy saving mode (light load) can be acquired. Hereinafter, such features will be described in detail.

### First Embodiment

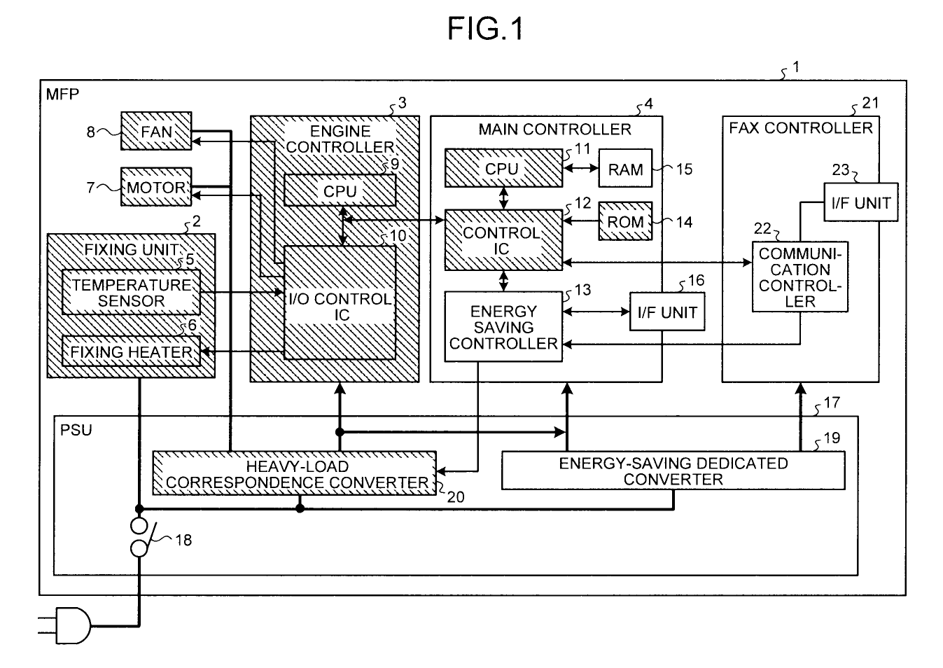

FIG. 1 is a block diagram illustrating an example of the hardware configuration of an MFP (digital MFP) as an image forming apparatus according to a first embodiment of the invention.

This MFP 1, when broadly divided, is configured by an engine unit (including an engine controller 3), a main controller 4, and a facsimile (FAX) controller 21. Among them, each unit of a driving system (each unit except for the engine controller 3 disposed inside the engine unit) and each unit of a control system (each unit disposed inside the engine controller 3, the main controller 4, and the FAX controller 21) correspond to a plurality of load units demanding power.

The engine unit, for example as illustrated in FIG. 1, is configured by a power supply unit (PSU) 17 that supplies power to the entire MFP 1 (hereinafter, also referred to as a “apparatus”), the engine controller 3 that controls the engine unit, and engine control targets such as a motor 7, a fan 8, and a fixing unit 2.

This engine unit configures a printer unit (image forming unit) and a scanner unit (image scanning unit) by using the engine control targets such as the above-described fixing unit 2 and can selectively perform a scanning operation, a printing operation, and a copying operation.

The scanner unit is an image scanning unit that reads out image data of a document by scanning the document.

The printer unit is an image forming unit that forms an image on a transfer sheet (or any other recording medium) through an image forming process using an electro-photographic method based on image data read out by the scanner unit or data received from a host device such as a personal computer (PC). In a case where the data received from the host device is not image data for image formation but a text code or drawing data, the received data is converted into image data for image formation by the main controller 4.

The scanning operation represents an operation of scanning image data of a document by using the scanner unit and storing the image data in a memory. The printing operation represents an operation of receiving data from a host device and forming an image based on the data. The copying operation represents an operation of scanning image data of a document by using the scanner unit and forming an image based on the image data scanned.

Here, briefly described will be an example of the configuration of the printing unit and a series of image forming processes using an electro-photographic method based thereon.

The printer unit includes a drum-shaped or belt-shaped photosensitive element as an image carrier in addition to the above-described fixing unit 2 and the like and, on the periphery thereof, an image generating process unit that is configured by a charging unit, an exposing unit, a developing unit, and a transfer unit.

The printer unit configured as above forms an electrostatic latent image by uniformly charging the surface of the photosensitive element, which rotates in the sub scanning direction, by using the charging unit; and exposing the surface through scanning of light beams, which are modulated in accordance with image data, emitted from the exposing unit in the main scanning direction (a direction orthogonal to the sub scanning direction).

Then, the electrostatic latent image is developed with toner supplied from the developing unit so as to be formed a toner image. The toner image is directly transferred onto a transfer sheet which is fed from the paper feeding unit by the transfer unit; or after the toner image is transferred onto a belt-shaped or a drum-shaped intermediate transfer body, the toner image is transferred onto a transfer sheet fed from the paper feeding unit. Thereafter, the transfer sheet on which the toner image has been transferred is conveyed to the fixing unit, and a fixing process is performed.

The fixing unit 2, which is a thermal fixing type, fixes the toner image on the conveyed transfer sheet by heating and pressing the toner image using a fixing roller (fixing unit) in which a fixing heater 6 (heating unit) is built.

This fixing unit 2 includes a temperature sensor 5 serving as a fixing temperature detecting unit detecting fixing temperature that is the temperature of the surface of the fixing roller. The engine controller 3 performs fixing control for matching the fixing temperature to target temperature by controlling ON/OFF (ON/OFF of the conduction to the fixing heater 6) of the fixing heater 6 based on the detection result (detected temperature) detected by the temperature sensor 5.

In addition, a fixing unit may be used which includes a fixing roller having an electromagnetically-induced heating layer therein and an IH coil unit that is an electromagnetic induction unit used for heating the electromagnetically-induced heating layer.

The PSU 17 is a power supply unit that supplies electric power to a plurality of load units and controls ON/OFF of power supply (hereinafter, it may be briefly referred to as “ON/OFF of the power source as well) to each unit based on the power supplied from an AC commercial power source (hereinafter, briefly referred to as an “AC power source”) by using an AC switch (ACSW) 18. The AC switch 18 has a feature of being directly operable by a user using a rocker switch in a mechanical manner.

In a case where the power is ON by turning on the AC switch 18, the PSU 17 supplies an AC power source (AC power) to the fixing unit 2 and internal converters. In addition, the PSU 17 may control ON/OFF of the AC power that is supplied to the fixing unit 2.

The PSU 17 includes a heavy-load correspondence converter 20 that is a power supply unit for a heavy load; and an energy-saving dedicated converter 19 as a power supply unit for a light load. The PSU 17 generates and supplies DC power of 12 V, 24 V, or the like for the motor 7 and the fan 8; and generates and supplies DC power of 5 V, 3.3 V, or the like for the control system by converting the AC power into DC power by using the converters 20 and 19 respectively.

The engine controller 3 controls the engine unit; and is configured by a CPU 9, an I/O control IC 10, and the like. The CPU 9 controls ON/OFF of the driving system (ON/OFF of conduction to the driving system) such as the motor 7, the fan 8, and the like through the I/O control IC 10 by executing a program that is stored in an internal ROM (or in a memory unit such as another ROM). In addition, the engine controller 3 performs fixing control by controlling ON/OFF of the fixing heater 6 as described above based on temperature information, which represents detected temperature, transmitted from the temperature sensor 5 disposed inside the fixing unit 2.

The main controller 4 is a main control unit that performs overall control of the entire apparatus; and is configured by a CPU 11 a control IC 12, a ROM 14, a RAM 15, an energy saving controller 13, and an interface (I/F) unit 16.

The CPU 11 performs apparatus/system control, interface control, and energy saving control by executing a program stored in the ROM 14 (or in a memory unit such as another ROM) and using the control IC 12, the energy saving controller 13, and the like.

The control IC 12 includes interfaces for the engine controller 3 and the FAX controller 21 and interfaces for the memory-related.

In the ROM 14, programs executed by the CPU 11 and various types of fixed data are stored.

The RAM 15 stores device management data therein and updates the information in accordance with the operating state. In addition, the same data as that stored in the ROM 14 may be stored in the RAM 15.

The I/F unit 16 is a host I/F (communication unit) that communicates with an external host device and is an network I/F such as a universal serial bus (USB) or a local area network (LAN).

The energy saving controller 13 performs energy saving control for realizing energy saving. This energy saving controller 13 achieves the function of a power control unit according to the invention together with the PSU 17.

The FAX controller 21 controls the FAX transmission and reception and is configured by a communication controller 22 and an I/F unit 23.

The communication controller 22 performs the FAX transmission for the outside thereof using the I/F unit 23 that is connected to a telephone circuit (public circuit)

Here, at the time of the normal mode, in order to maintain both the heavy-load correspondence converter 20 and the energy-saving dedicated converter 19 to be in the ON state, the heavy-load correspondence converter 20 supplies power (DC power) to load units disposed inside the engine unit including the engine controller 3 and load units disposed inside the main controller 4, which require power only at the time of the normal mode, denoted with diagonal lines being applied thereto in FIG. 1; and the energy-saving dedicated converter 19 supplies power to load units disposed inside the main controller 4 and load units disposed inside the FAX controller 21, which require power all the time, denoted with no diagonal lines being applied thereto in FIG. 1. However, the power that is deficient in the load units requiring power all the time is supplemented by supplying power from the heavy-load correspondence converter 20 to the output power source system of the energy saving dedicated converter 19. At the time of the energy saving mode, since the heavy-load correspondence converter 20 is in the OFF state due to stopping of the output of a ready signal from the energy saving controller 13, the energy-saving dedicated converter 19 supplies power only to the load units that require power all the time.

In other words, since the energy saving controller 13, the RAM 15, and the I/F unit 16, which are disposed inside the main controller 4, and the communication controller 22 and the I/F unit 23, which are disposed inside the FAX controller 21, denoted with no diagonal lines being applied thereto in FIG. 1 are the load units that require power all the time, power is supplied thereto from the energy-saving dedicated converter 19 that constantly maintains the ON state after the startup of the apparatus. On the other hand, since the other units (including the heavy-load correspondence converter 20 disposed inside the PSU 17) are the load units (load units other than the load units requiring power all the time) that require power only at the time of the normal mode, power is not supplied from the heavy-load correspondence converter 20 that is in the OFF state at the time of the energy saving mode. The mode of the apparatus is returned to the normal mode (the operating state) from the energy saving mode (the energy saving state) in accordance with an instruction (a print command or the like) transmitted from the I/F unit 16.

In order to improve the power efficiency, the energy-saving dedicated converter 19 sets a maximum current value to be small. Accordingly, when the normal mode is returned from the energy saving mode, the power (particularly, the increase in the power consumption of the RAM 15) during the operation of the main controller 4 cannot be covered by supplying power only from the energy-saving dedicated converter 19, and thus the heavy-load correspondence converter 20 supplements power that is deficient in the output power source system of the energy-saving dedicated converter 19.

Although not illustrated in the figure, in order not to supply power from the energy-saving dedicated converter 19 to the output power source system of the heavy-load correspondence converter 20 (in other words, in order not to allow a current to flow), a circuit including a diode needs to be used. Alternatively, by using a circuit including a diode and a transistor such as an FET and allowing the energy saving controller 13 to control the ON/OFF of the transistor, the power is supplemented from the heavy-load correspondence converter 20 to the output power source system of the energy-saving dedicated converter 19 only at the time of the normal mode, whereby the supply of power from the energy-saving dedicated converter 19 to the output power source system of the heavy-load correspondence converter 20 can be reliably prevented.

In addition, instead of supplementing power from the heavy-load correspondence converter 20 to the output power source system of the energy-saving dedicated converter 19, the supply of power from the energy-saving dedicated converter 19 may be stopped by allowing the energy-saving dedicated converter 19 to be in the OFF state due to an operation by the energy saving controller 13 for shifting the supply of power from the heavy-load correspondence converter 20.

Furthermore, by eliminating the energy saving controller 13 from the configuration and constantly supplying power to the CPU 11, the CPU 11 may be configured to achieve the function of the energy saving controller 13 by executing a program.

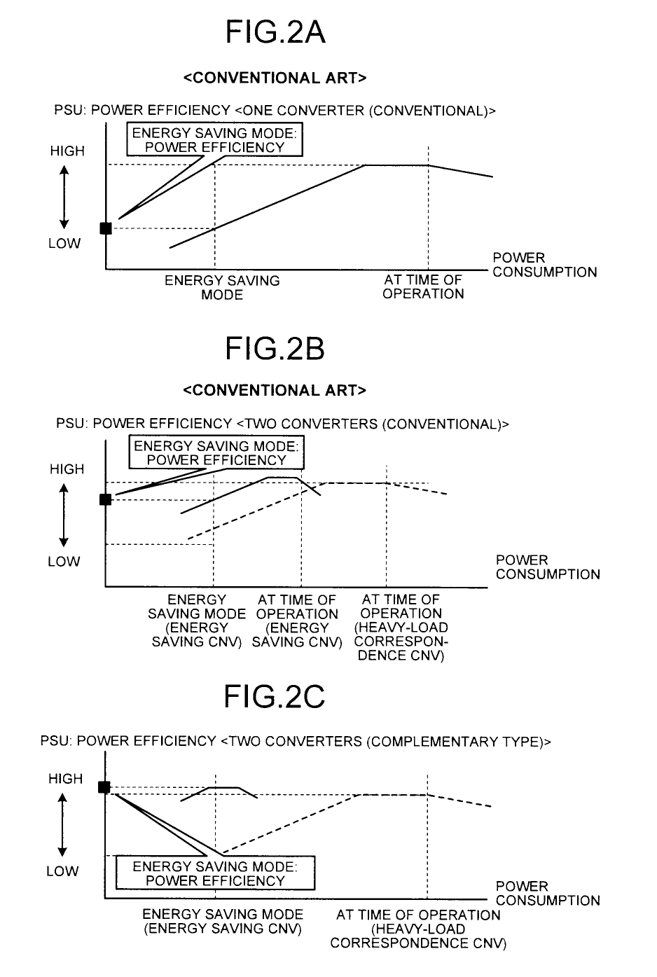

FIGS. 2A to 2C are waveform diagrams illustrating examples of the power efficiency of power supply units (PSU) according to a “One-Converter Type (Conventional)”, a “Two-Converter Type (Conventional)”, and a “Two-Converter Supplementary Type”.

Generally, since the power efficiency changes depending on the power consumption, and the maximum current value of the apparatus does not increase, the power efficiency is set so as to increase as the power consumption is increased.

In the “One-Converter Type (Conventional)”, since the PSU includes only one converter, power supply at the time of the operation (the normal mode) and power supply at the time of the energy saving mode need to be performed by using one single converter. Accordingly, the covered range is wide, and, as illustrated in FIG. 2A, so the power efficiency at the time of the energy saving mode decreases.

Thus, according to the two-converter mode (conventional), for example, as illustrated in FIG. 2B, the power efficiency at the time of the energy saving mode is improved. When described with reference to FIG. 1, the energy-saving dedicated converter (energy saving CNV) 19 is provided in addition to the heavy-load correspondence converter (heavy-load correspondence CNV) 20, and power is supplied only to the energy saving controller 13, the RAM 15, and the I/F unit 16 disposed inside the main controller 4 and the communication controller 22 and the I/F unit 23 disposed inside the FAX controller 21 at the time of the energy saving mode, whereby the maximum current is set to be low. Accordingly, the range of power supplied by the energy-saving dedicated converter 19 can be set to be small, whereby improvement in the power efficiency is intended.

However, while the maximum current of the control system block (the load units to which diagonal lines are not applied in FIG. 1) that supplies power at the time of the energy saving mode remains at the same level based on the improvement of the functions at the time of the operation (normal mode) and the like, technology for lowering the power at the time of the energy saving mode advances, whereby the power efficiency at the time of the energy saving mode also decreases in the two-converter type.

Thus, in the “Two-Converter Supplementary Type” according to the first embodiment, as described with reference to FIG. 1, the power that is deficient in the output power source system of the energy-saving dedicated converter 19 at the time of the operation (at the time of a heavy load) is supplemented by the heavy-load correspondence converter 20 (or the apparatus is switched into the supply of power from the heavy-load correspondence converter 20). Accordingly, since the maximum power consumption supplied by the energy-saving dedicated converter 19 can be reduced so as to restrict the power supply range, for example, as illustrated in FIG. 2C, high power efficiency can be achieved.

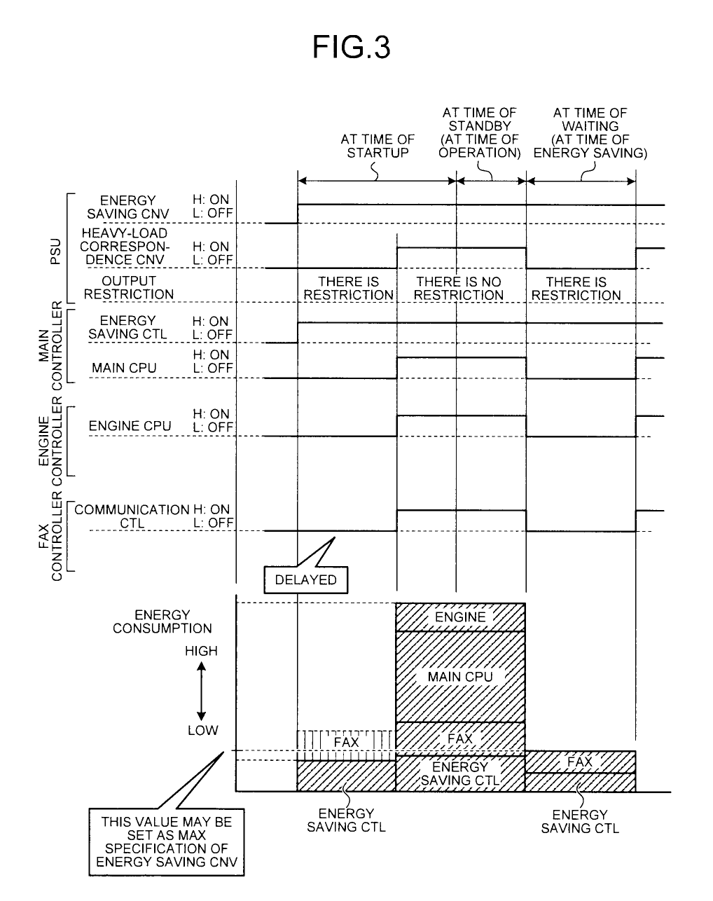

FIG. 3 is a timing chart illustrating the relation between the ON/OFF states of the PSU 17 (the converters 19 and 20), the main controller 4, the engine controller 3, and the FAX controller 21 illustrated in FIG. 1 and the power consumption.

In the MFP 1 illustrated in FIG. 1, the PSU 17, for example as illustrated in FIG. 3, allows the energy-saving dedicated converter 19 (energy saving CNV) to be in the ON state at the time of startup of the apparatus so as to supply power to control system blocks (load units) requiring power, which includes the energy saving controller 13 (energy saving CTL), at the time of energy saving (that is, constantly). At this time, since the maximum current value of the energy-saving dedicated converter 19 is small, the energy saving controller 13, which is started up by being supplied with the power (power on), delays the startup of other control system blocks such as the communication controller 22 (communication CTL) disposed inside the FAX controller 21. Accordingly, power is not consumed in the control system blocks.

Thereafter, when a delay time set in advance elapses, the energy saving controller 13 outputs a ready signal (startup signal) to other control system blocks that require power at the time of the energy saving mode and outputs a ready signal also to the heavy-load correspondence converter 20 so as to allow the heavy-load correspondence converter 20 to be in the ON state, so that power is supplied to driving system blocks, which include the engine controller 3 (the control system block including the CPU 9) configuring the engine unit, the motor 7, and the fan 8, requiring power only at the time of the operation and control system blocks, which include the CPU 11 disposed inside the main controller 4, requiring power only at the time of the operation by the heavy-load correspondence converter 20.

Simultaneously, power that is deficient in the control system block, which includes the communication controller 22 (communication CTL) disposed inside the FAX controller 21, requiring power all the time is supplemented by the heavy-load correspondence converter 20. Accordingly, the communication controller 22 can be started up in accordance with the ready signal and consumes power.

Consequently, the apparatus is shifted to the operating state (normal mode). However, the operating state immediately after the startup is a standby state (standby mode) in which various operations such as the copying operation, the scanning operation, and the printing operation can be selectively performed immediately and is different from the waiting state (energy saving state).

After being shifted to the operation mode, in a case where there is no operation request such as a print command even when a defined time set in advance elapses, the operations of the CPU 11 and the like disposed inside engine unit and the main controller 4 are not necessary, and accordingly, the apparatus is shifted to the energy saving mode as the waiting state.

When shifted to the energy saving mode, the energy saving controller 13 stops outputting of the ready signal to the heavy-load correspondence converter 20, so that the heavy-load correspondence converter 20 becomes the OFF state. Accordingly, power is supplied only from the energy-saving dedicated converter 19.

Here, as described above, in order to raise the power efficiency of the energy-saving dedicated converter 19, it is important to decrease the maximum power (maximum current) to be supplied. Although a low-power state can be formed at the time of the energy saving mode by stopping the clock, partially turning off the power (stopping the supply of the power), or the like, it is difficult to perform a control operation; and, generally, the power of a level that is higher than that at the time of the energy saving mode is consumed at the time of inputting power to the apparatus (at the time of startup). Accordingly, by partially delaying the startup of the power at the time of inputting the power, the maximum power at the time of the startup can be reduced.

### Second Embodiment

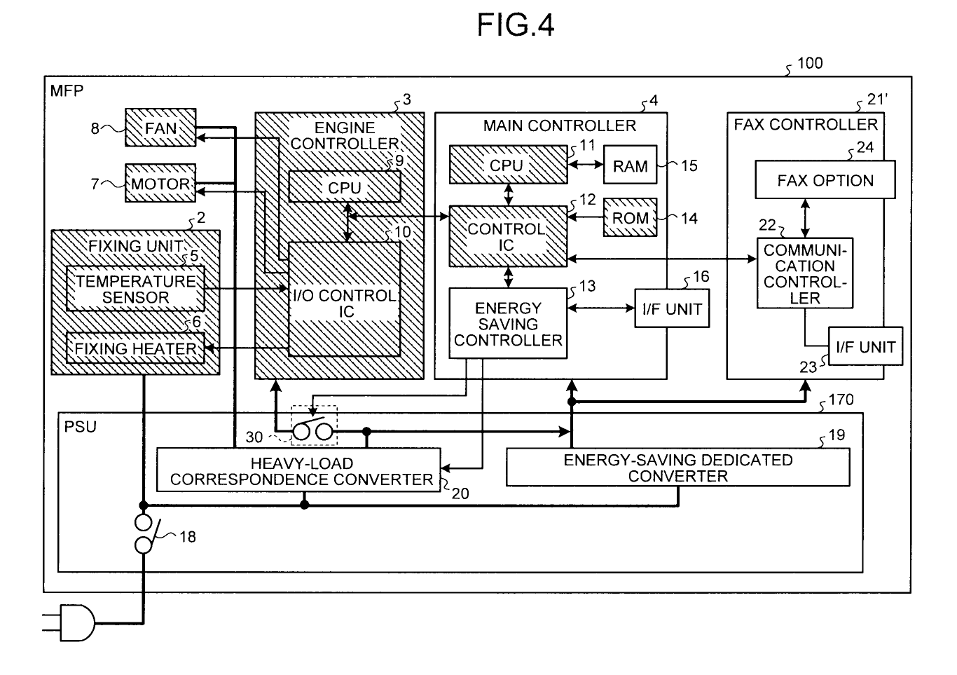

FIG. 4 is a block diagram illustrating an example of the hardware configuration of an MFP as an image forming apparatus according to a second embodiment of the invention, and the same reference numeral is assigned to the same portion thereof as that shown in FIG. 1.

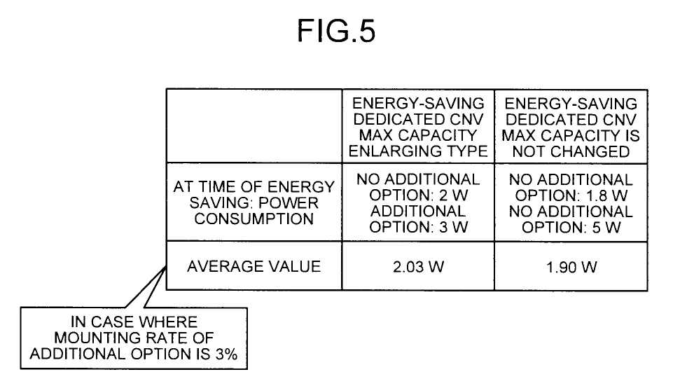

FIG. 5 is a table illustrating the power supply state of an MFP 100.

As described above, in order to raise the power efficiency of the energy-saving dedicated converter 19, it is important to decrease the maximum power to be supplied.

Thus, according to the MFP 100 of the second embodiment, the above-described energy saving mode is set as a first energy saving mode in which the power consumption can be reduced the most. In addition, when an option having a low mounting rate is connected (installed), the connection thereof is detected by a communication controller 22 disposed inside a FAX controller 21′ and notifies an energy saving controller 13 of the detection, and accordingly, the energy saving controller 13 that has received the notification maintains the state of the heavy-load correspondence converter 20 to the ON state and proceeds to a second energy saving mode in which the power consumption is slightly higher (relatively high) than that of the first energy saving mode. Therefore, the communication controller 22 achieves the function of an option detecting unit, and the energy saving controller 13 achieves the function of an energy saving state shifting unit.

In this MFP 100, a case is shown as an example in which an option of a FAX (FAX option) 24 is added. In a case where the FAX option 24 is not added, the operations are the same as those described with reference to FIGS. 1 to 3, and thus the description thereof is omitted. In a case where the FAX option 24 is added, since the energy-saving dedicated converter 19 disposed inside a PSU 170 cannot cover the maximum power in the second energy saving mode, and accordingly, the energy saving controller 13 does not allow the heavy-load correspondence converter 20 to be in the OFF state by not stopping the output of the ready signal to the heavy-load correspondence converter 20.

Accordingly, although the CPU 11 of the main controller 4 is also maintained to be in the ON state, the energy saving controller 13 turns off a switching unit 30 so as to stop the supply of power to the engine unit.

In addition, at the time of the second energy saving mode, by allowing the energy-saving dedicated converter 19 to be in the OFF state, power can be supplied to necessary control system blocks only from the heavy-load correspondence converter 20.

Here, assuming that the mounting rate of the additional option is 3%, for example, as illustrated in FIG. 5, in a case where the energy-saving dedicated converter 19 is optimized without any option (the maximum capacity is not changed) can decrease the total amount of power consumption (here, the averages are compared) more than that in a case where the range of power supply of the energy-saving dedicated converter 19 is widened in accordance with the additional option (the maximum capacity is enlarged).

According to this second embodiment, in accordance with the addition of the option, the apparatus proceeds to the second energy saving mode and maintains the heavy-load correspondence converter 20 to be in the ON state. However, it may be configured such that the type of the installed option is detected, and the apparatus proceeds to the first energy saving mode so as to allow the heavy-load correspondence converter 20 to be in the OFF state in a case where the power consumption is low and the ON state of the heavy-load correspondence converter 20 does not need to be maintained as a result of the detection, based on the type of the additional option. In addition, control can be performed in a similar manner for the type of a used I/F as the I/F unit 16 of the main controller 4. For example, in a case where the USB I/F is used, when the network I/F is used in the first energy saving mode, the apparatus proceeds to the second energy saving mode. In such a case, the energy saving controller 13 achieves the function of an I/F type detecting unit.

### Third Embodiment

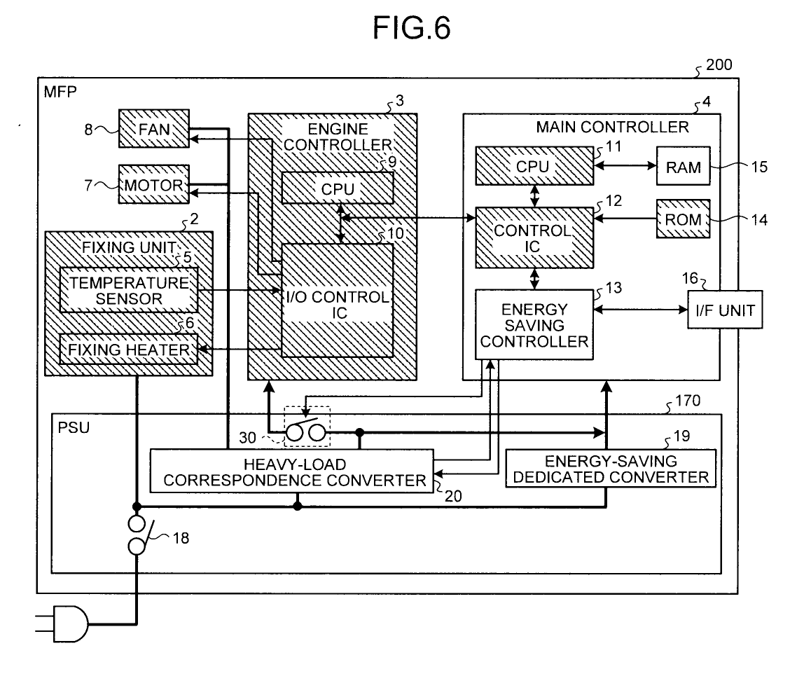

FIG. 6 is a block diagram illustrating an example of the hardware configuration of an MFP as an image forming apparatus according to a third embodiment of the invention, and the same reference numeral is assigned to the same portion thereof as that shown in FIG. 4. In addition, for convenience of the drawing, the FAX controller 21′ is omitted in the figure.

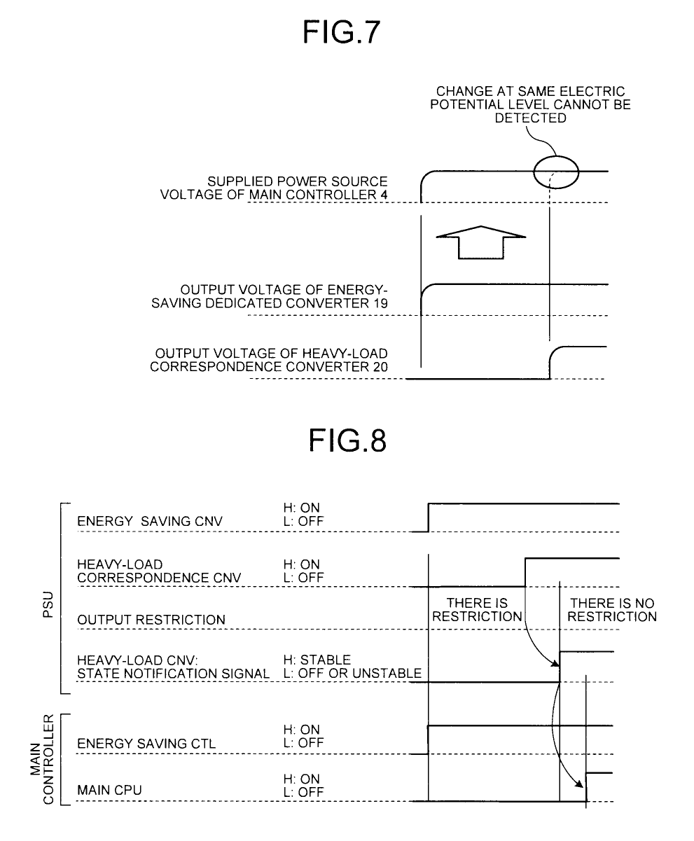

FIG. 7 is a waveform diagram illustrating an example of the relation among the input voltage of the main controller 4, the output voltage of the energy-saving dedicated converter 19, and the output voltage of the heavy-load correspondence converter 20 illustrated in FIG. 6.

FIG. 8 is a timing chart illustrating an example of the operation timing of the PSU 170 and the main controller 4 shown in FIG. 6.

In a case where the output voltages of the energy-saving dedicated converter 19 and the heavy-load correspondence converter 20 shown in FIG. 6 have the same electric potential level, the energy saving controller 13 disposed inside the main controller 4 cannot recognize the stable state of the heavy-load correspondence converter 20 based on the power source voltage supplied to the main controller 4. The reason for this is that, although the heavy-load correspondence converter 20 is in the ON state in the middle of a state in which the energy-saving dedicated converter 19 has been already in the ON state, for example, as illustrated in FIG. 7, the output electric potentials of the converters 19 and 20 have the same level, and the change thereof does not appear in the power source voltage that is supplied to the main controller 4.

Thus, in an MFP 200 according to the third embodiment, the PSU 170 side notifies the energy saving controller 13 disposed inside the main controller 4 of the stable state of the output voltage of the heavy-load correspondence converter 20. This notification can be performed by detecting the state of the output voltage of the heavy-load correspondence converter 20 using a feedback circuit unit disposed inside the heavy-load correspondence converter 20. Accordingly, the feedback circuit unit disposed inside the heavy-load correspondence converter 20 corresponds to a state detecting and notifying unit.

For example, as illustrated in FIG. 8, when receiving the notification indicating the stable state of the output voltage of the heavy-load correspondence converter 20 from the PSU 170 (the state notification signal is in the high level “H” representing the stable state), the energy saving controller 13 allows control system blocks, which include the CPU 11 disposed inside the main controller 4, requiring power only at the time of the operation mode to be in the ON State. In a case where the heavy-load correspondence converter 20 is to be set to the OFF state, the energy saving controller 13 allows the CPU 11 in the OFF state and then allows the heavy-load correspondence converter 20 to be in the OFF state.

### Fourth Embodiment

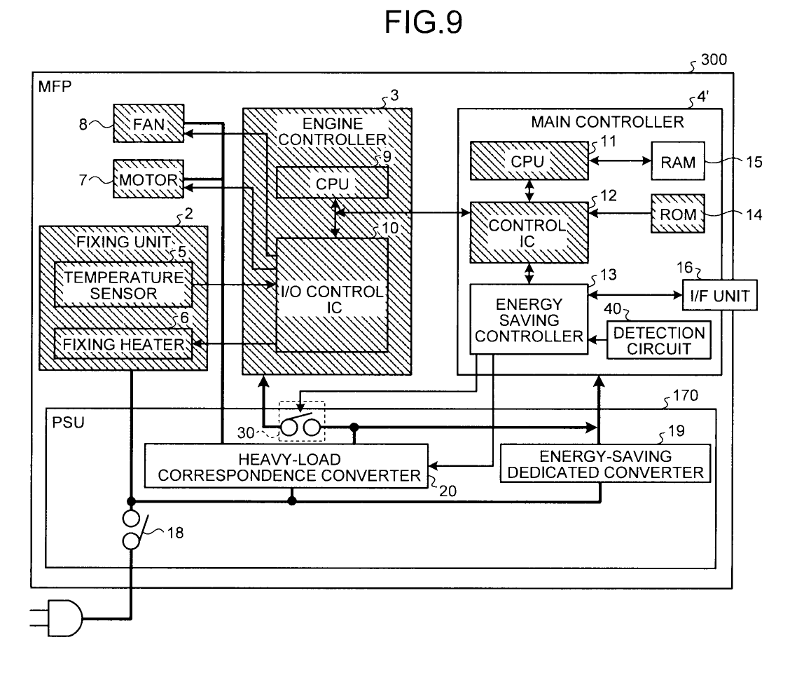

FIG. 9 is a block diagram illustrating an example of the hardware configuration of an MFP as an image forming apparatus according to a fourth embodiment of the invention, and the same reference numeral is assigned to the same portion thereof as that shown in FIG. 6.

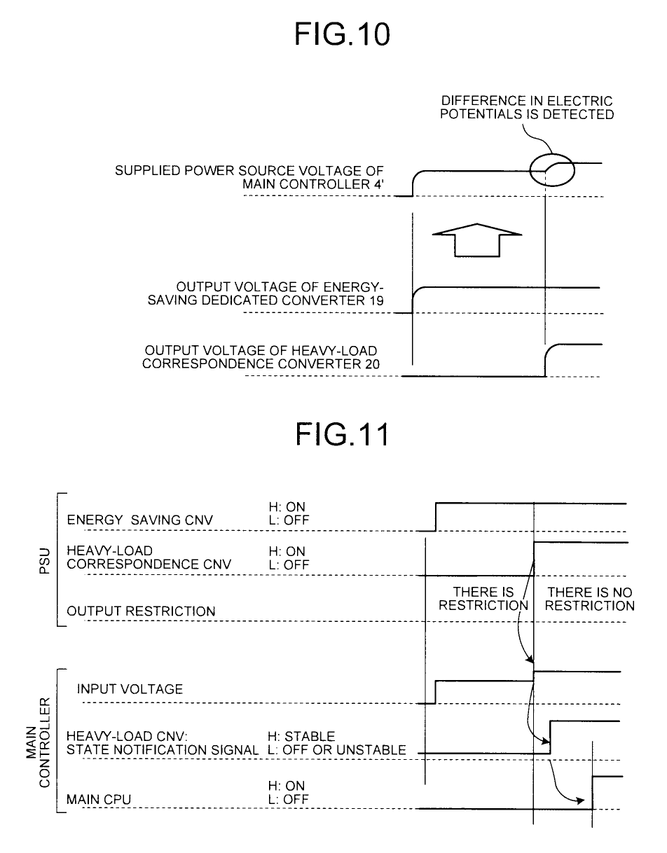

FIG. 10 is a waveform diagram illustrating an example of the relation among the input voltage of a main controller 4′, the output voltage of the energy-saving dedicated converter 19, and the output voltage of the heavy-load correspondence converter 20 illustrated in FIG. 9.

FIG. 11 is a timing chart illustrating an example of the operation timing of the PSU 170 and the main controller 4′ illustrated in FIG. 9.

In a case where the output voltages of the energy-saving dedicated converter 19 and the heavy-load correspondence converter 20 shown in FIG. 9 are not the same level, the main controller 4′ can detect the ON/OFF state of the heavy-load correspondence converter 20. The reason for this is that, in a case where the heavy-load correspondence converter 20 is in the ON state in the middle of a state in which the energy-saving dedicated converter 19 has been already in the ON state, for example, as illustrated in FIG. 10, the power source voltage (input voltage) supplied to the main controller 4 changes at that timing.

Thus, in an MFP 300 according to the fourth embodiment, a detection circuit 40 that detects a change in the power source voltage and notifies the energy saving controller 13 of the detected change is disposed in the main controller 4′. For example, assuming that, in a case where the power source voltage is 5 Volt (V), the output voltage of the heavy-load correspondence converter 20 is 5 V so as to allow the heavy-load correspondence converter 20 to be in the ON state and, in a case where the power source voltage is 3.3 V, the output voltage of the energy-saving dedicated converter 19 is 3.3 V so as to allow the heavy-load correspondence converter 20 to be in the OFF state, in a case where the power source voltage changes from 3.3 V to 5 V, the detection circuit 40 can detect the change. Therefore, the detection circuit 40 can achieve the function of the state detecting and notifying unit together with the energy saving controller 13.

For example, as illustrated in FIG. 10, when the power source voltage of the main controller 4′ changes, the energy saving controller 13 receives a notification indicating the change from the detection circuit 40. In this example, in a case where the state of the changed power source voltage is stable, the detection circuit 40 notifies of the stable state. However, the stability may be determined by the energy saving controller 13.

For example, as illustrated in FIG. 11, when the power source voltage (input voltage) of the main controller 4′ changes, and a notification indicating the stable state of the changed power source voltage is received from the detection circuit 40 (the state notification signal is in the high level “H” indicating a stable state), the energy saving controller 13 allows control system blocks, which include the CPU 11 disposed inside the main controller 4′, requiring power only at the time of the operation mode to be in the ON state. In a case where the heavy-load correspondence converter 20 is to be set to the OFF state, the energy saving controller 13 allows the CPU 11 to be in the OFF state and then allows the heavy-load correspondence converter 20 to be in the OFF state.

### Fifth Embodiment

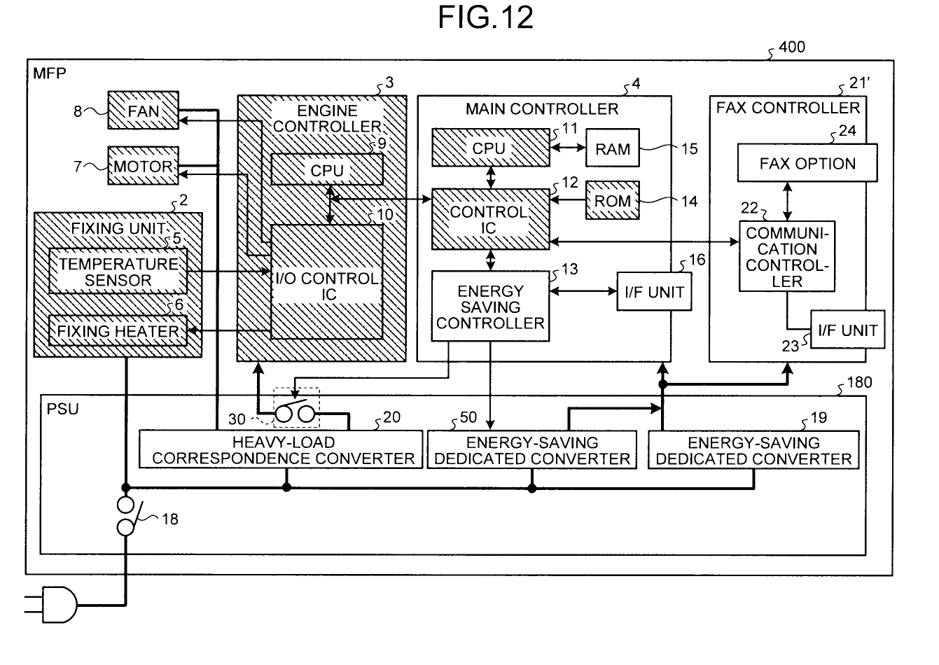

FIG. 12 is a block diagram illustrating an example of the hardware configuration of an MFP as an image forming apparatus according to a fifth embodiment of the invention, and the same reference numeral is assigned to the same portion thereof as that shown in FIG. 4.

Various configurations of options, that is, a plurality of types of options can be connected to the MFP, and, particularly in a case where an I/F system option including the FAX is connected thereto, power needs to be supplied also at the time of the energy saving mode.

However, as described with reference to FIG. 4, according to the method in which the heavy-load correspondence converter 20 is set to the ON state at the time of the energy saving mode, the power range covered by the heavy-load correspondence converter 20 is wide, and the power efficiency is essentially lowered, whereby the low power consumption at the time of the energy saving mode is not achieved.

Thus, in an MFP 400 according to the fifth embodiment, a new energy-saving dedicated converter 50 is added, and, in a case where an option type that cannot be covered by the energy-saving dedicated converter 19 is connected thereto, the energy-saving dedicated converter 50 is controlled to be in the ON state. In addition, as the standard configuration, in a case where the option type can be responded by using only the energy-saving dedicated converter 19, the energy-saving dedicated converter 50 is set to the OFF state, and the decrease in the power consumption is measured.

The above-described control operation will be described in more detail.

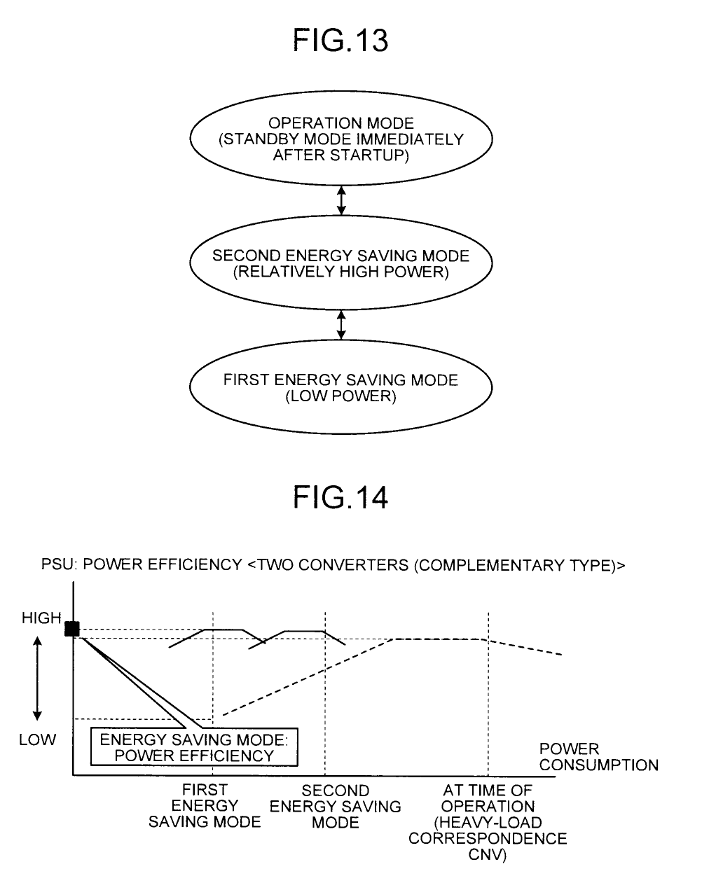

FIG. 13 is a schematic diagram illustrating a detailed state transition and the power efficiency of an MFP 400 illustrated in FIG. 12.

FIG. 14 is a waveform diagram illustrating an example of the power efficiency of a PSU 180 illustrated in FIG. 12.

In this MFP 400, the energy saving controller 13 proceeds to the standby mode (the operation mode immediately after startup) immediately after startup and sets all the converters, that is, the heavy-load correspondence converter 20 and the energy-saving dedicated converters 19 and 50 to the ON state. Accordingly, various operations such as a copying operation, a scanning operation, and a printing operation can be selectively performed.

In addition, similarly to the second embodiment, the MFP 400 has: a first energy saving mode in which the power consumption can be reduced the most; and a second energy saving mode in which the power consumption is higher than that in the first energy consumption mode as the energy saving modes. In the case of a standard configuration, the apparatus proceeds to the first energy saving mode at an appropriate timing described above so as to allow only the energy-saving dedicated converter 19 to be in the ON state. Accordingly, power is supplied to the load units disposed inside the main controller 4 and the load units disposed inside the FAX controller 21′, which are denoted with diagonal lines not being applied thereto in FIG. 12, that require power all the time by the energy-saving dedicated converter 19.

In addition, in a case where an option or the like is connected thereto, the apparatus proceeds to the second energy saving mode so as to allow the energy-saving dedicated converters 19 and 50 to be in the ON state. Accordingly, power is supplied to the load units disposed inside the main controller 4 and the load units disposed inside the FAX controller 21′ that require power all the time by the energy-saving dedicated converters 19 and 50.

Accordingly, as illustrated in FIG. 14, in the first or second energy saving mode, the power efficiency can be maintained at not positions denoted by a broken line but positions denoted by a solid line.

On the other hand, at the time of the operation mode, both the heavy-load correspondence converter 20 and the energy-saving dedicated converter 19 to be in the ON state, the heavy-load correspondence converter 20 supplies power to the load units disposed inside the engine unit including the engine controller 3 and the load units disposed inside the main controller 4, which require power only at the time of the operation mode, denoted with diagonal lines being applied thereto in FIG. 12; and the energy-saving dedicated converter 19 supplies power to the load units disposed inside the main controller 4 and the load units disposed inside the FAX controller 21′, which require power all the time, denoted with diagonal lines not being applied thereto in FIG. 12. However, the power that is deficient in the load units requiring power all the time is supplemented by the other energy-saving dedicated converter 50.

In addition, shifting between the first energy saving mode and the second energy saving mode can be performed in accordance with the type of the option or the I/F that is connected. For example, in a case where a USB I/F is connected as the I/F unit 16, the mode is shifted to the first energy saving mode, and, in a case where a network I/F is connected, the mode is shifted to the second energy saving mode. Therefore, the communication controller 22 functions as an option detecting unit, and the energy saving controller 13 functions as an energy saving state shifting unit and an I/F type detecting unit.

In this embodiment, although two energy-saving dedicated converters are included, three or more energy-saving dedicated converters may be included. In such a case, in the case of the standard configuration or the like, it may be configured that the apparatus proceeds to the first energy saving mode, and a predetermined energy-saving dedicated converter that is determined in advance is allowed to be in the ON state. On the other hand, in a case where an option or the like is connected, it may be configured that the apparatus proceeds to the second energy saving mode, and one, two, or more energy-saving dedicated converters other than the predetermined energy-saving dedicated converter are allowed to be in the ON state.

Although the embodiments have been described as above in which the invention is applied to a digital MFP, the invention is not limited thereto and may be applied to various electronic apparatuses such as other image forming apparatuses including a digital copier, a FAX device, and a printer, an electric appliance, an automatic vending machine, a medical apparatus, a power source device, an air conditioning system, a measurement system of gas, water, electricity, or the like, an AV apparatus, a game device, and a computer.

### Program According to the Invention

This program is a program used for allowing a CPU as a computer that controls an electronic apparatus to realize the function of each unit such as the power control unit according to the invention, and by allowing the CPU to execute the program, the operations and the advantages as described above can be acquired.

The program may be initially stored in a memory unit such as a ROM, a non-volatile memory (a flash ROM, an EEPROM, or the like) or an HDD that is included in an electronic apparatus. Alternatively, the program may be provided with being recorded on a CD-ROM as a recording medium or a non-volatile recording medium (memory) such as a memory card, a flexible disc, an MO, a CD-R, a CD-RW, a DVD+R, a DVD+RW, a DVD-R, a DVD-RW, or a DVD-RAM. By installing the program recorded on such a recording medium to an electronic apparatus and allowing the CPU to execute the program or by allowing the CPU to read out the program from such a recording medium and execute the program, the above-described procedure can be performed.

Furthermore, the program may be downloaded from an external device, which is connected to a network, having a recording medium on which the program is recorded or an external device having a memory unit in which the program is stored and be executed.

An electronic apparatus according to the invention allows power to be supplied only to load units requiring power all the time, out of a plurality of load units, by a power supply unit for a light load at the time of waiting (at the time of energy saving) and allows power to be supplied to the load units requiring power all the time by the power supply unit for a light load and power that is deficient in the load units to be supplemented by a power supply unit for a heavy load at the time of the operation. Accordingly, the range of the load capacity that is covered by the power supply unit for a light load can be set to be narrow, and thus both a high power efficiency at the time of the operation (at the time of a heavy load) and a high power efficiency at the time of waiting (at the time of a light load) can be acquired.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic apparatus comprising:
a plurality of load units that require power;
a power supply unit that supplies power to the plurality of load units,
the power supply units including
a power supply unit for a heavy load and
a power supply unit for a light load; and
a power control unit that
controls power to be supplied only to a load unit which requires power all the time, out of a plurality of load units, from the power supply unit for a light load during an energy saving state, and
controls power to be supplied to a load unit which requires power all the time during an operating state from the power supply unit for a light load, and at the same time,
controls deficient power of the load unit to be supplemented by the power supply unit for a heavy load during the operating state,
wherein
a state of the electronic apparatus can be switched to any one of a plurality of apparatus states including
the operating state in which a normal operation is performed and
the energy saving state in which power consumption can be reduced.

2. The electronic apparatus according to claim 1,
wherein
the power control unit controls power to be supplied to the load unit other than the load unit that requires power all the time, out of the plurality of the load units, from the power supply unit for a heavy load during the operating state.

3. The electronic apparatus according to claim 1,
wherein a plurality of load units are included as the load units that require power all the time, and
wherein
the power control unit, at the time of a startup state where the electronic apparatus is started-up,
turns on the power supply unit for a light load so as to supply power only to some of the load units which require power all the time, out of the load units which require power all the time, and
then turns on the power supply unit for a heavy load so as to supply power also to the remaining load units, out of the load units which require power all the time.

4. The electronic apparatus according to claim 1, further comprising:
an option detecting unit that
is supplied with the power all the time by the power supply unit for a light load and
detects presence or absence of an option or the type of an option,
wherein
the power control unit controls power to be supplied from the power supply unit for a heavy load or from both the power supply unit for a heavy load and the power supply unit for a light load during the energy saving state, based on a detection result acquired by the option detecting unit.

5. The electronic apparatus according to claim 4, further comprising:
an energy saving state shifting unit that switches to a first energy saving state or a second energy saving state, based on the detection result acquired by the option detecting unit,
wherein the energy saving state includes
a first energy saving state in which power consumption can be reduced the most and
a second energy saving state in which power consumption is relatively higher than that in the first energy saving state, and
wherein the power control unit
controls power to be supplied from the power supply unit for a light load during the first energy saving state, and
controls power to be supplied from the power supply unit for a heavy load or from both the power supply unit for a heavy load and the power supply unit for a light load during the second energy saving state.

6. The electronic apparatus according to claim 1,
wherein the power supply unit for a heavy load and the power supply unit for a light load have the same electric potential level in output voltage, and
wherein the power supply unit for a heavy load includes a state detecting and notifying unit that
is supplied with the power all the time,
detects a state of an output voltage thereof, and
notifies the power control unit of the state of the output voltage.

7. The electronic apparatus according to claim 6,
wherein the state detecting and notifying unit notifies the power control unit of a state when the output voltage becomes stable.

8. The electronic apparatus according to claim 1, further comprising:
a state detection and notifying unit that
is supplied with the power all the time from the power supply unit for a light load,
detects a change in an input voltage, and
notifies the power control unit of the detected change,
wherein the power supply unit for a heavy load and the power supply unit for a light load have different electric potential levels in output voltage.

9. The electronic apparatus according to claim 8,
wherein the state detecting and notifying unit
detects the change in the input voltage and then
notifies the power control unit of a state when the input voltage becomes stable.

10. The electronic apparatus according to claim 7,
wherein the power control unit starts a load unit up other than the load units which require power all the time, out of the plurality of the load units, when the notification is received.

11. The electronic apparatus according to claim 1 wherein,
the power supply unit includes a plurality of power supply units for a light load,
wherein the electronic apparatus further comprises
an option detecting unit which
is supplied with power all the time by the power supply unit for a light load that is determined in advance, out of a plurality of power supply units for a light load, and
detects presence or absence of an option or a type of an option; and
a power control unit that
controls power to be supplied only to a load unit which requires power all the time, out of the plurality of load units, based on a detection result acquired by the option detecting unit,
from a power supply unit for a light load that is determined in advance or
from the power supply unit for a light load and another power supply unit for a light load, out of the plurality of power supply units for a light load, during an energy saving state, and
controls power to be supplied to a load unit which requires power all the time from the power supply unit for a light load that is determined in advance and, at the same time,
controls deficient power in the load unit to be supplemented by the another power supply unit for a light load during the operating state, and
wherein a state of the electronic apparatus can be switched to any one of a plurality of apparatus states including the operating state in which a normal operation is performed and the energy saving state in which power consumption can be reduced.

12. The electronic apparatus according to claim 11,
wherein the energy saving state includes a first energy saving state in which power consumption can be reduced the most and a second energy saving state in which power consumption is higher than that in the first energy saving state,
wherein the electronic apparatus further comprising
an energy saving state shifting unit that switches to the first energy saving state or the second energy saving state based on the detection result acquired by the option detecting unit, and
wherein the power control unit
controls power to be supplied from the power supply unit for a light load, which is determined in advance, during the first energy saving state, and
controls power to be supplied
from the power supply unit for a light load that is determined in advance and
from both the power supply unit for a light load that is determined in advance and the another power supply unit for a light load during the second energy saving state.

13. An image forming apparatus configured as the electronic apparatus according to claim 1, comprising:
an image forming unit that forms an image on a recording medium;
a communication unit that communicates with outside the apparatus; and
a main control unit that performs overall control of the apparatus,
wherein the load unit which requires power all the time, out of the plurality of load units, includes a portion of the power control unit disposed inside the communication unit and the main control unit, and
the load unit other than the load unit which requires power all the time, out of the plurality of load units, includes a remaining portion disposed inside the main control unit and the image forming unit.

14. A computer program product comprising a non-transitory computer-usable medium having computer-readable program codes embodied in the medium for controlling an electronic apparatus that
includes
a plurality of load units that require power, and
a power supply unit for a heavy load and a power supply unit for a light load that supply power to the plurality of load units, and
switches a state of the electronic apparatus to any one of a plurality of apparatus states including an operating state in which a normal operation is performed and an energy saving state in which power consumption is reduced, the program codes when executed causing a computer to execute:
controlling, during the energy saving state, power to be supplied only to a load unit which requires power all the time, out of the plurality of load units, from the power supply unit for a light load; and
controlling power to be supplied to a load unit which requires power all the time from the power supply unit for a light load, and also
controlling deficient power of the load unit to be supplemented by the power supply unit for a heavy load during the operating state.
